(19) United States
(12) Patent Application Publication
(10) Pub. No.: US 2011/0037755 A1
(43) Pub. Date: Feb. 17, 2011

(54) DRIVING METHOD OF PLASMA DISPLAY PANEL

(76) Inventors: Toshiyuki Maeda, Hyogo (JP); Yutaka Yoshihama, Osaka (JP); Shinya Tsuchida, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/988,582

(22) PCT Filed: Apr. 2, 2010
(86) PCT No.: PCT/JP2010/002440

§ 371 Date: Oct. 19, 2010

(30) Foreign Application Priority Data
Apr. 13, 2009 (JP) 2009-096828

(51) Int. Cl. G09G 5/00; G09G 3/28

(52) U.S. Cl. 345/211; 345/60

(57) ABSTRACT

A driving method of an alternating-current surface discharge type PDP is provided. In the initializing period. an operation that applies a predetermined voltage for causing discharge regardless of the presence or absence of the former discharge to a scan electrode and causes the initializing discharge in the discharge cell is assumed as a forcibly initializing operation. In the address period, the time when a scan pulse is applied to the scan electrode and an address pulse is applied to the data electrode is assumed to be address time. In each of discharge cells, the forcibly initializing operation is performed in one of a plurality of fields, and the address time in the address period of a field that does not, undergo the forcibly initializing operation is set to be longer than the address time in the address period of a field that undergoes the forcibly initializing operation.

### TECHNICAL FIELD

The present invention relates to a driving method of an alternating-current surface discharge type plasma display panel.

### BACKGROUND ART

There is an alternating-current surface discharge type panel as a typical panel of plasma display panels (hereinafter referred to as “panel”). In this alternating-current surface discharge type panel, a front substrate having a plurality of display electrode pairs each of which is formed of a pair of scan electrode and sustain electrode is faced to a rear substrate having a plurality of data electrodes in parallel. Many discharge cells are formed between the front substrate and the rear substrate. In each discharge cell, gas discharge is caused to generate ultraviolet rays, and the ultraviolet rays excite red, green, and blue phosphors to emit light to perform color display.

A general method of driving the panel is a subfield method. In this method, one field is divided into a plurality of subfields, and the subfields in which light is emitted are combined, thereby performing gradation display. In each subfield, an initializing operation, an address operation, and a sustain operation are performed sequentially. In the initializing operation, initializing discharge is caused in a discharge cell, and a wall charge required for the subsequent address operation is formed. This initializing operation includes a forcibly initializing operation of causing initializing discharge regardless of the operation in the immediately preceding subfield, and a selective initializing operation of causing the initializing discharge only in the discharge cell where address discharge is performed in the immediately preceding subfield. In the address operation, address discharge is selectively caused according to the image to be displayed, and wall charge is formed in the corresponding discharge cell. In the sustain operation, sustain pulses are alternately applied to the display electrode pairs to cause the sustain discharge, and a phosphor layer of the corresponding discharge cell is made to emit light.

Among such subfield methods, a driving method of performing the forcibly initializing operation once for one field using a gently varying ramp waveform voltage is disclosed in patent literature 1. In this driving method, the light emission that is not related to the gradation display is minimized to improve the contrast.

Patent literature 2 discloses a driving method where a display electrode pair is divided into n and the forcibly initializing operation is performed once for n fields. In this driving method, the light emission that is not related to the gradation display is further reduced, and the contrast is further improved.

When the number of forcibly initializing operations is reduced simply, however, the address operation becomes unstable disadvantageously. This is because priming is insufficient in a discharge cell for displaying black, namely in a discharge cell for causing no sustain discharge. When the address operation becomes unstable, sustain discharge does not occur in the discharge cell to emit light, and the image display quality of the panel reduces. When the number of forcibly initializing operations is reduced simply, flicker also occurs disadvantageously. This is because reducing the number of forcibly initializing operations allows light emission occurring in the initializing discharge to be recognized. This causes reduction in image display quality.

### CITATION LIST

### [Patent Literature]

[Patent Literature 1] Unexamined Japanese Patent Publication No. 2000-242224

[Patent Literature 2] Unexamined Japanese Patent Publication No. 2006-091295

### SUMMARY OF THE INVENTION

The present invention provides a driving method of a plasma display panel having a plurality of discharge cells that includes a scan electrode, a sustain electrode, and a data electrode. In. this driving method, one field is formed of a plurality of subfields having an initializing period, an address period, and a sustain period. In the initializing period, an operation that applies a predetermined voltage for causing discharge regardless of the presence or absence of the former discharge to the scan electrode and causes the initializing discharge in the discharge cell is assumed as a forcibly initializing operation. In the address period, the time when a scan pulse is applied to the scan electrode and an address pulse is applied to the data electrode is assumed to be address time. In each of discharge cells, the forcibly initializing operation is performed in one of a plurality of fields, and the address time in the address period of a field that does not undergo the forcibly initializing operation is set to be longer than the address time in the address period of a field that undergoes the forcibly initializing operation. In the present invention, even when the number of forcibly initializing operations is set to be one for a plurality of fields, the flicker can be suppressed and stable address operation can be performed.

Therefore, a panel driving method capable of achieving both display of a high-contrast image and display of a high-quality image by stable address operation can be provided.

### BRIEF DESCRIPTION OF DRAWINGS

FIG. 1 is an exploded perspective view of a panel used in a plasma display device in accordance with a first exemplary embodiment of the present invention.

FIG. 2 is an electrode array diagram of the panel used in the plasma display device.

FIG. 3 is a waveform chart of driving voltage to be applied to each electrode of the plasma display device.

FIG. 4 is a diagram showing the relationship between a scan electrode and a field that undergo. forcibly initializing in accordance with the first. exemplary embodiment of the present invention.

FIG. 5 is a circuit block diagram of the plasma display device in accordance with the first exemplary embodiment of the present invention.

FIG. 6 is a circuit diagram of a scan electrode driving circuit of the plasma display device.

FIG. 7 is a timing chart for illustrating an operation of the scan electrode driving circuit of the plasma display device.

FIG. 8 is a diagram showing the relationship between a discharge cell and a field that undergo forcibly initializing in accordance with a second exemplary embodiment of the present invention.

### DETAILED DESCRIPTION OF PREFERRED EMBODIMENTS

A plasma display device in accordance with exemplary embodiments of the present invention will be described hereinafter with reference to the accompanying drawings.

### First Exemplary Embodiment

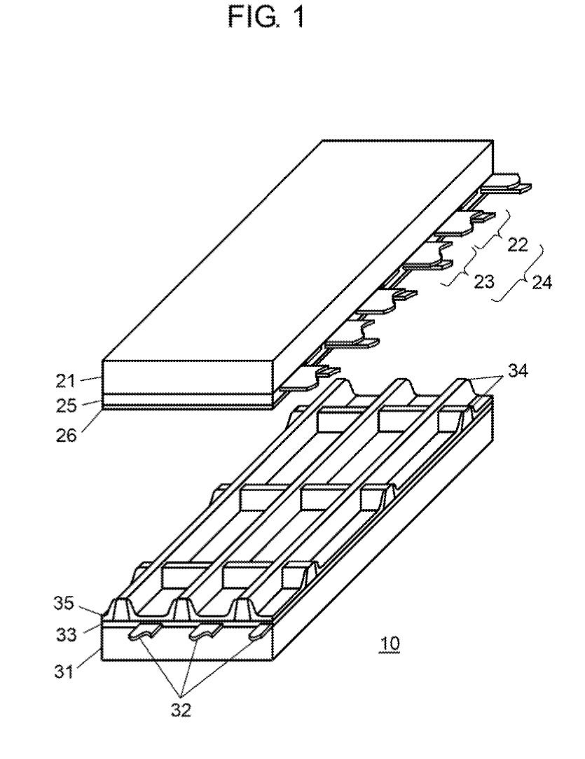

FIG. 1 is an exploded perspective view of panel 10 used in a plasma display device in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover display electrode pairs 24, and protective layer 26 is formed on dielectric layer 25. A plurality of data electrodes 32 is formed on rear substrate 31. Dielectric layer 33 is formed so as to cover data electrodes 32, and mesh barrier ribs 34 are formed on dielectric layer 33. Phosphor layers 35 for emitting lights of respective colors of red, green, and blue are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. The discharge space is partitioned into a plurality of sections (discharge cells) by barrier ribs 34. Discharge cells are formed in the intersecting portions of display electrode pairs 24 and data electrodes 32. The discharge cells discharge and emit light to display an image.

The structure of panel 10 is not limited to the above-mentioned one, but may be a structure having striped barrier ribs, for example.

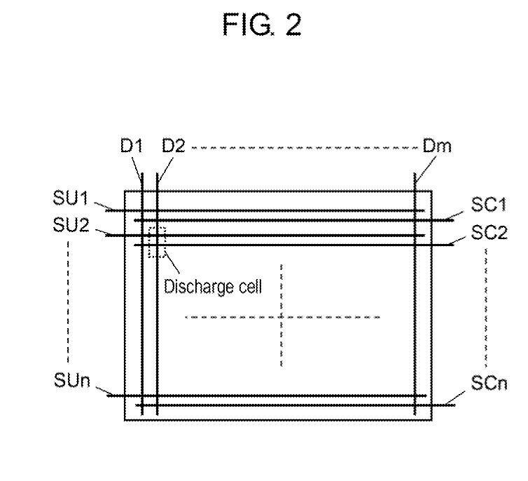

FIG. 2 is an electrode array diagram of panel 10 used in the plasma display device in accordance with the first exemplary embodiment of the present invention. In panel 10, n long scan electrodes SC1 through SCn (scan electrodes 22 in FIG. 1) and n long sustain electrodes SU1 through SUn (sustain electrodes 23 in FIG. 1) are alternately arranged in the row direction. In the column direction, m long data electrodes D1 through Dm (data electrodes 32 in FIG. 1) are arranged. A discharge cell is formed in the portion where a pair of scan electrode SCi (i is 1 through n) and sustain electrode SUi intersect with one data electrode Dj (j is 1 through m). Thus, mxn discharge cells are formed in the discharge space.

Next, a driving voltage waveform and its operation for driving panel 10 are described.

The plasma display device displays an image by a subfield method. In the subfield method, one field is divided into a plurality of subfields, and light emission and no light emission of each discharge cell is controlled in each subfield. In each subfield, an initializing operation, an address operation, and a sustain operation are sequentially performed. In the initializing operation, initializing discharge is caused in each discharge cell, and wall charge required for the subsequent address discharge is formed on each electrode. This initializing operation includes a forcibly initializing operation of causing initializing discharge in the discharge cell regardless of the presence or absence of the former discharge, and a selective initializing operation of causing the initializing discharge only in the discharge cell where sustain discharge has been performed in the immediately preceding subfield. In the address operation, address discharge is selectively caused in the discharge cell to emit light, and wall charge is formed. In the sustain operation, as many sustain pulses as the number corresponding to a luminance weight predetermined for each subfield are alternately applied to the display electrode pairs, and the sustain discharge is caused to emit light in the discharge cell where the address discharge has been caused.

In the subfield structure, for example, one field is divided into 10 subfields (SF1, SF2, . . . , SF10), and respective subfields have luminance weights of (1, 2, 3, 6, 11, 18, 30, 44, 60, 80). The forcibly initializing operation is performed in SF1, and the selective initializing operation is performed in SF2 through SF10. However, the present invention is not limited to this subfield structure.

In the present embodiment, in SF1, the forcibly initializing operation is not performed in all discharge cells, but is performed in a discharge cell having a specific scan electrode. At this time, the forcibly initializing operation is not performed in the other discharge cells. Detail of the specific scan electrode is described later, and one example of the driving voltage waveform is firstly described.

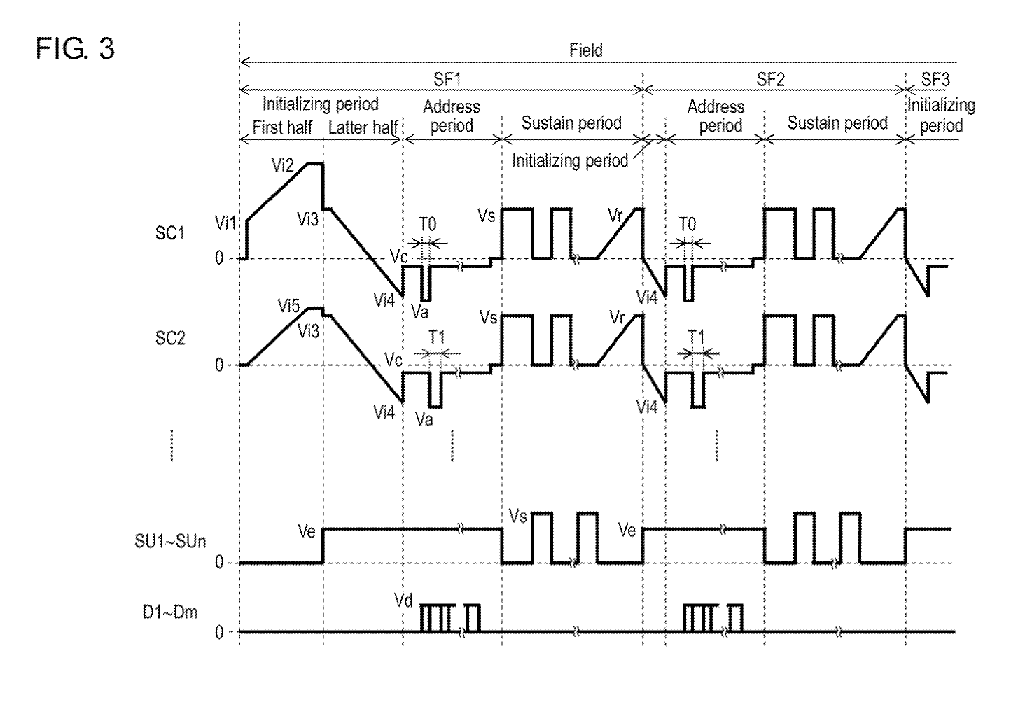

FIG. 3 is a waveform chart of driving voltage applied to each electrode of the plasma display device in accordance with the first exemplary embodiment of the present invention. FIG. 3 shows driving voltage waveforms applied to scan electrode SC1, scan electrode SC2, sustain electrodes SU1 through SUn, and data electrodes D1 through Dm in the initializing period of SF1 through the initializing period of SF3. In FIG. 3, the forcibly initializing operation is performed in a discharge cell having scan electrode SC1, and is not performed in a discharge cell having scan electrode SC2.

In the first half of the initializing period of SF1, voltage 0 (V) is applied to data electrodes D1 through Dm, and voltage 0 (V) is also applied to sustain electrodes SU1 through SUn. The following up-ramp waveform voltage is applied to scan electrode SC1 as a scan electrode (hereinafter referred to as “scan electrode undergoing the forcibly initializing operation”) to which a driving voltage waveform for performing the forcibly initializing operation is applied. Here, the up-ramp waveform voltage gently increases from voltage at which discharge does not occur, to predetermined voltage Vi2 (hereinafter, simply referred to as “voltage Vi2”), at which discharge occurs regardless of the presence or absence of the former discharge. Then, feeble initializing discharge occurs between scan electrode SC1 and sustain electrode SU1, and feeble initializing discharge occurs between scan electrode SC1 and data electrodes D1 through Dm. Negative wall voltage is accumulated on scan electrode SC1, and positive wall voltage is accumulated on data electrodes D1 through Dm and sustain electrode SU1. The wall voltage on the electrodes means voltage generated by the wall charge that is accumulated on the dielectric layer for covering the electrodes, the protective layer, or the phosphor layers.

While, the following up-ramp waveform voltage is applied to scan electrode SC2 as a scan electrode (hereinafter referred to as “scan electrode undergoing no forcibly initializing operation”) to which a driving voltage waveform for performing the forcibly initializing operation is not applied. Here, the up-ramp waveform voltage gently increases from voltage 0 (V) to voltage Vi5, which is lower than voltage Vi2. Therefore, initializing discharge does not occur in the discharge cell having undergone no sustain discharge in at least the immediately preceding subfield.

Thus, in the first half of the initializing period of SF1, the up-ramp waveform voltage, which gently increases to voltage Vi2 at which discharge occurs regardless of the presence or absence of the former discharge, is applied to the scan electrode undergoing the forcibly initializing operation. The up-ramp waveform voltage, which gently increases to voltage Vi5 lower than voltage Vi2, is applied to the scan electrode undergoing no forcibly initializing operation.

In the latter half of the initializing period of SF1, voltage 0 (V) is applied to data electrodes D1 through Dm, and voltage Ve is applied to sustain electrodes SU1 through SUn. Down-ramp waveform voltage, which gently decreases from voltage Vi3 to voltage Vi4, is applied to scan electrodes SC1 through SCn. Then, feeble initializing discharge occurs again in the discharge cell having undergone the feeble initializing discharge in the first half of the initializing period of SF1. The feeble initializing discharge reduces the wall voltage on a scan electrode and sustain electrode of the corresponding discharge cell. The excessive part of the wall voltage of data electrodes D1 through Dm is discharged to adjust the wall voltage to be appropriate for address operation. In addition, priming of reducing the discharge delay time of the address discharge occurs. While, discharge does not occur in a discharge cell having undergone no initializing discharge in the first half of the initializing period of SF1. Therefore, the former wall voltage is kept, and the priming does not occur.

Thus, the forcibly initializing operation is performed in the discharge cell having a scan electrode to which the up-ramp waveform voltage increasing to voltage Vi2, at which discharge occurs regardless of the presence or absence of the former discharge, has been applied. While, the forcibly initializing operation is not performed in the discharge cell having a scan electrode to which the up-ramp waveform voltage increasing to voltage Vi5, which is lower than voltage Vi2, has been applied.

In the subsequent address period of SF1, voltage Vc is first applied to scan electrodes SC1 through SCn. Next, for a predetermined period, a scan pulse of voltage Va is applied to scan electrode SC1 of the first row, and an address pulse of voltage Vd is applied to data electrode Dk corresponding to the discharge cell to emit light. After the discharge delay time in the discharge cell of the first row, address discharge occurs between data electrode Dk and scan electrode SC1, and address discharge occurs between sustain electrode SU1 and scan electrode SC1. Positive wall voltage is accumulated on scan electrode SC1, and negative wall voltage is accumulated on sustain electrode SU1 and data electrode Dk. Thus, address operation is performed that causes address discharge in the discharge cell to emit light in the first row and accumulates wall voltage on each electrode. The voltage in the portion where the data electrode having received no address pulse intersects with scan electrode SC1 does not exceed the discharge start voltage, so that address discharge does not occur.

A predetermined time when a scan pulse and an address pulse are simultaneously applied is referred to as “address time” hereinafter. The address time for scan electrode SC1 of the first row is time T0. The priming caused by the forcibly initializing operation remains in the discharge cell of the first row, so that the discharge delay of the address discharge is short. Therefore, address time T0 can be set to be short.

Next, a scan pulse is applied to scan electrode SC2 of the second row, and an address pulse of voltage Vd is applied to data electrode Dk corresponding to the discharge cell to emit light. At this time, the address time of scan electrode SC2 of the second row is time T1 longer than time T0. Then, after the discharge delay time in the discharge cell of the second row, address discharge occurs between data electrode Dk and scan electrode SC1, and address discharge occurs between sustain electrode SU1 and scan electrode SC1. Positive wall voltage is accumulated on scan electrode SC1, and negative wall voltage is accumulated on sustain electrode SU1 and data electrode Dk. Thus, address operation is performed that causes address discharge in the discharge cell to emit light in the second row and accumulates wall voltage on each electrode. The voltage in the portion where the data electrode having received no address pulse intersects with scan electrode SC1 does not exceed the discharge start voltage, so that address discharge does not occur.

Here, the forcibly initializing operation is not performed in the discharge cell of the second row, so that priming is insufficient in the discharge cell that has not undergone sustain discharge, and the discharge delay of the address discharge becomes long. The address time of scan electrode SC2 of the second row is set to be time T1 longer than time T0.

A similar address operation is performed until scan electrode SCn of the n-th-row, wall charge required for the subsequent sustain discharge is produced. The address time of the discharge cell having undergone the forcibly initializing operation is time T0, and the address time of the discharge cell having undergone no forcibly initializing operation is time T1 longer than time T0. In the present embodiment, the address time for the scan electrode having undergone no forcibly initializing operation is set to be longer than the address time of the scan electrode having undergone the forcibly initializing operation.

In the subsequent sustain period of SF1, voltage 0 (V) is applied to sustain electrodes SU1 through SUn, and a sustain pulse of voltage Vs is applied to scan electrodes SC1 through SCn. Then, in the discharge cell having undergone the address discharge, the voltage difference between scan electrode SCi and sustain electrode SUi is obtained by adding the difference between the wall voltage on scan electrode SCi and that on sustain electrode SUi to voltage Vs, and exceeds the . discharge start voltage. Thus, sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell having undergone no address discharge, sustain discharge does not occur and the wall voltage at the end of the initializing period is kept.

Subsequently, voltage 0 (V) is applied to scan electrodes SC1 through SCn, and a sustain pulse of voltage Vs is applied to sustain electrodes SU1 through SUn. In the discharge cell having undergone the sustain discharge, sustain discharge occurs again and phosphor layer 35 emits light. Negative wall voltage is accumulated on sustain electrode SUi, and positive wall voltage is accumulated on scan electrode SCi. Hereinafter, similarly, as many sustain pulses as the number corresponding to the luminance weight are alternately applied to scan electrodes SC1 through SCn and sustain electrodes SU1 through SUn, and sustain discharge is continuously performed in the discharge cell having undergone address discharge.

After the sustain operation, up-ramp waveform voltage gently increasing to voltage Vr is applied to scan electrodes SC1 through SCn. Then, in the discharge cell having undergone the sustain discharge, erasing discharge occurs, and wall voltage on scan electrode SCi and sustain electrode SUi is erased while positive wall voltage on data electrode Dk is remained.

When the number of sustain pulses corresponding to the luminance weight is “0”, the up-ramp waveform voltage gently increasing to voltage Vr is applied to scan electrodes SC1 through SCn to cause erasing discharge without applying sustain pulses to scan electrodes SC1 through SCn and sustain electrodes SU1 through SUn. Thus, the sustain operation is completed.

In the initializing period of SF2, 0 (V) is applied to data electrodes D1 through Dm, and voltage Ve is applied to sustain electrodes SU1 through SUn. Down-ramp waveform voltage gently decreasing to voltage Vi4 is applied to scan electrodes SC1 through SCn. Then, feeble initializing discharge occurs in the discharge cell having caused sustain discharge in the immediately preceding subfield, and wall voltage on scan electrode SCi and sustain electrode SUi is reduced. The excessive part of the wall voltage of data electrode Dk is discharged to adjust the wall voltage to be appropriate for address operation. Thus, the selective initializing operation is completed.

In the subsequent address period of SF2, similarly to the address period of SF1, scan pulses are sequentially applied to the scan electrodes, and an address pulse is applied to data electrode Dk corresponding to the discharge cell to emit light to perform address operation.

Also in the address period of SF2, the address time of the scan electrode having undergone the forcibly initializing in SF1 is time T0, and the address time of the scan electrode having undergone no forcibly initializing in SF1 is time T1 longer than time T0. Thus, the address time for the scan electrode having undergone no forcibly initializing in SF1 is set to be longer than the address time for the scan electrode having undergone the forcibly initializing.

The operation of the subsequent sustain period of SF2 is the same as that of the sustain period of SF1 except for the number of sustain pulses, and hence is not described. The operations of SF3 through SF10 are the same as the operation of SF2 except for the number of sustain pulses: Also in the address periods of SF3 through SF10, the address time of the scan electrode having undergone the forcibly initializing operation in SF1 is time T0, and the address time of the scan electrode having undergone no forcibly initializing operation in SF1 is time T1 longer than timer T0.

In the present embodiment, voltage Vi1 is 150 (V), voltage Vi2 is 400 (V), voltage Vi3 is 210 (V), voltage Vi4 is −180 (V), voltage Vi5 is 250 (V), voltage Vc is −50 (V), voltage Va is −200 (V), voltage Vs is 210 (V), voltage Vr is 210 (V), voltage Ve is 140 (V), and voltage Vd is 75 (V). Address time T0 of the scan electrode having undergone forcibly initializing is 1.0 μs. Address time T1 of the scan electrode having undergone no forcibly initializing is 1.5 μs. These voltage values and address times are not limited to the above-mentioned values, and preferably are set optimally based on the discharge characteristic of the panel or the specification of the plasma display device.

Next, the relationship between a specific scan electrode and a field that undergo forcibly initializing is described. In the present exemplary embodiment, the specific scan electrode undergoing the forcibly initializing operation is set in each field based on the following rules. When the forcibly initializing operation is performed in one field of N continuous fields (N is natural number) for one scan electrode, N temporally continuous fields are set as one field group, and N continuously arranged scan electrodes are set as one scan electrode group.

(Rule 1) The field where the forcibly initializing operation is performed in one scan electrode is one field of each field group.

(Rule 2) The scan electrode undergoing the forcibly initializing operation in one field is one scan electrode of each scan electrode group.

When N>5,

(Rule 3) in a scan electrode adjacent to the scan electrode undergoing the forcibly initializing operation in a certain field, the forcibly initializing operation is not performed in at least the field and a field next to the field.

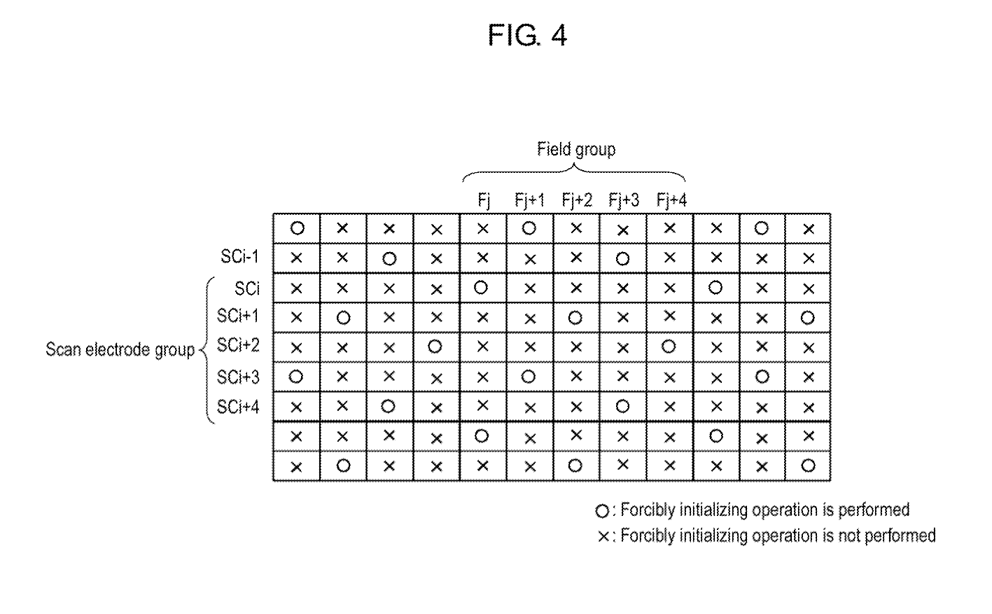

FIG. 4 is a diagram showing the relationship between the scan electrode and the field that undergo the forcibly initializing in accordance with the first exemplary embodiment of the present invention. FIG. 4 shows one example of N=5. The horizontal axis shows fields, and the vertical axis shows scan electrodes. One field group is formed of fields Fj through Fj+4, and one scan electrode group is formed of scan electrodes SCi through SCi+4.“O” shows that the forcibly initializing operation is performed, and “x” shows that the forcibly initializing operation is not performed.

As is clear from FIG. 4, scan electrode SCi undergoes the forcibly initializing operation in one field of each field group. Scan electrodes SCi+1 through SCi+4 are similar to scan electrode SCi (Rule 1). In this case, the number of forcibly initializing operations is reduced to ⅕ of that in the case where the forcibly initializing operation is performed in all discharge cells for each field. Therefore, the luminance of black level of a display image can be also reduced to ⅕. In field Fj, the forcibly initializing operation is performed in one scan electrode of each scan electrode group. Fields Fj+1 through Fj+4 are similar to field Fj (Rule 2). Thus, scan electrodes undergoing the forcibly initializing operation can be dispersed in respective fields. Therefore, flicker can be reduced. Scan electrode SCi undergoes the forcibly initializing operation in field Fj, and scan electrode SCi−1 and scan electrode SCi+1 that are adjacent to scan electrode SCi do not undergo the forcibly initializing operation in field Fj and the next field Fj+1. Scan electrodes SCi+1 through SCi+4 are similar to scan electrode SCi (Rule 3). Thus, temporal continuity and spatial continuity of the scan electrode undergoing the forcibly initializing operation can be reduced. Therefore, light emission following the forcibly initializing operation is hardly recognized.

In the present embodiment, the address time set for each scan electrode is set to be time T0 in the fields having “O”, and is set to be time Ti longer than time T0 in the fields having “x”. This is because the priming caused by the initializing discharge remains and discharge delay to address discharge becomes short in the field having undergone the forcibly initializing operation, and hence a stable address operation can be performed even when the address time is set to be short. In the field having undergone no forcibly initializing operation, the priming is insufficient and discharge delay to the address discharge becomes long in the discharge cell undergoing no sustain discharge. Therefore, the address discharge is stably caused by setting the address time to be long to some extent.

The present embodiment achieves stable address operation in each discharge cell by the following processes:
performing the forcibly initializing operation once in one field of a plurality of continuous fields; and
setting the address time in the address period in the field undergoing no forcibly initializing operation to be longer than that in the field undergoing the forcibly initializing operation.

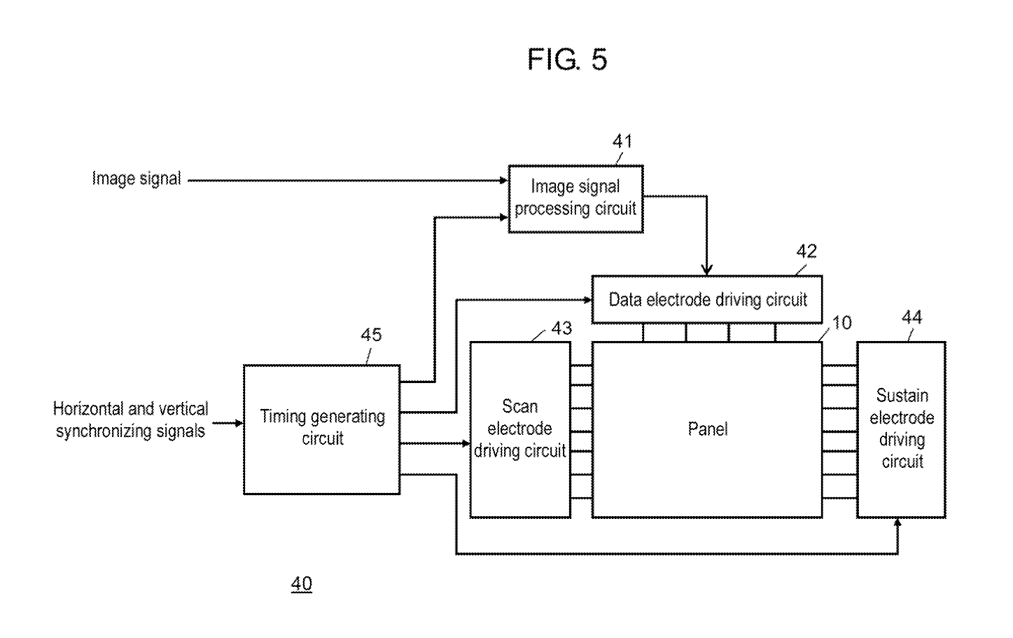

Next, a driving circuit for driving panel 10 and its operation are described. FIG. 5 is a circuit block diagram of plasma display device 40 of the first exemplary embodiment of the present invention. Plasma display device 40 has panel 10 and its driving circuit. The driving circuit includes the following elements:
image signal processing circuit 41;
data electrode driving circuit 42;
scan electrode driving circuit 43;
sustain electrode driving circuit 44;
timing generating circuit 45: and
a power supply circuit (not shown) for supplying power required for each circuit block.

Image signal processing circuit 41 converts an input image signal into image data that indicates light emission or no light emission in each subfield. Data electrode driving circuit 42 converts the image data in each subfield into an address pulse corresponding to each of data electrodes D1 through Dm, and applies it to each of data electrodes D1 through Dm. Timing generating circuit 45 generates various timing signals for controlling operations of respective circuit blocks based on vertical and horizontal synchronizing signals, and supplies the timing signals to respective circuit blocks. Scan electrode driving circuit 43 generates the above-mentioned driving voltage waveforms based on the timing signals, and supplies them to respective scan electrodes SC1 through SCn. Sustain electrode driving circuit 44 generates the driving voltage waveforms based on the timing signals, and applies them to sustain electrodes SU1 through SUn.

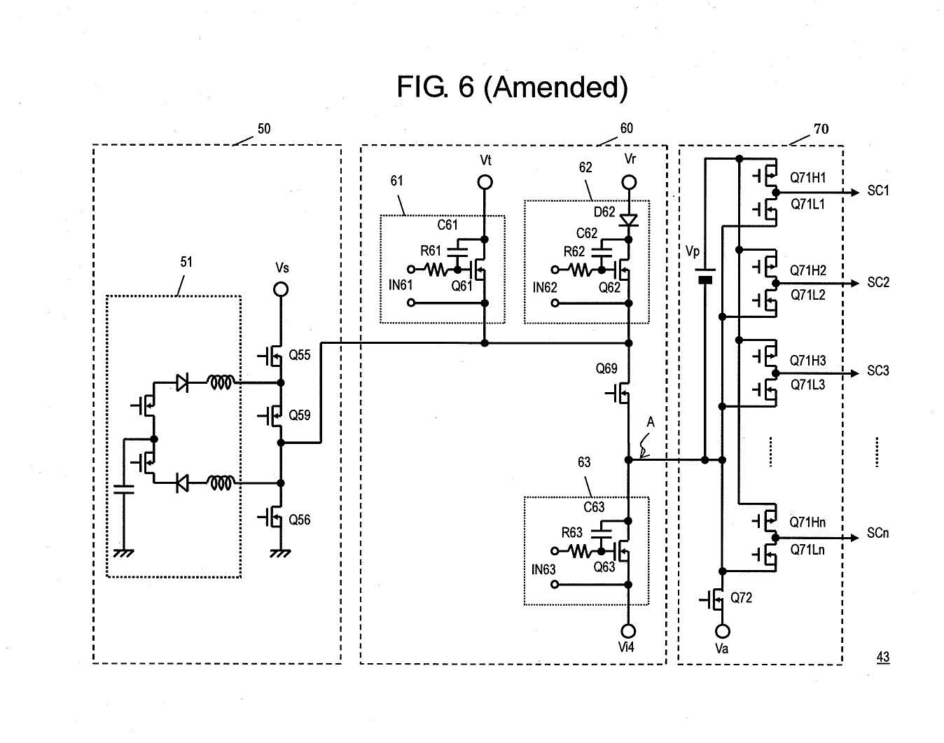

FIG. 6 is a circuit diagram of scan electrode driving circuit 43 of the plasma display device 40 in accordance with the first exemplary embodiment of the present invention. Scan electrode driving circuit 43 has sustain pulse generating circuit 50, ramp waveform voltage generating circuit 60, and scan pulse generating circuit 70.

Sustain pulse generating circuit 50 has electric power recovering circuit 51, switching element Q55, switching element Q56, and switching element Q59, and generates a sustain pulse applied to scan electrodes SC1 through SCn. Electric power recovering circuit 51 recovers electric power when scan electrodes SC1 through SCn are driven, and reuses the power. Switching element Q55 clamps scan electrodes SC1 through SCn on voltage Vs, and switching element Q56 clamps scan electrodes SC1 through SCn on voltage 0 (V). Switching element Q59 is a separating switch, and prevents current from flowing back via a parasitic diode or the like of a switching element that forms scan electrode driving circuit 43.

Scan pulse generating circuit 70 has switching elements Q71H1 through Q71Hn, and Q71L1 through Q71Ln, and switching element Q72. Scan pulse generating circuit 70 generates scan pulses based on the power supply of voltage Vp superimposed on reference potential (potential at node A shown in FIG. 6) thereof and the power supply of voltage Va, and sequentially applies the scan pulses to each of scan electrodes SC1 through SCn at timing of FIG. 3. Scan pulse generating circuit 70 outputs output voltage of sustain pulse generating circuit 50 as it is during the sustain operation. In other words, scan pulse generating circuit 70 outputs the voltage of node A to scan electrodes SC1 through SCn.

Ramp waveform voltage generating circuit 60 has Miller integrating circuits 61 through 63, and generates the ramp waveform voltage of FIG. 3. Miller integrating circuit 61 has transistor Q61, capacitor C61, and resistor R61, and generates up-ramp waveform voltage that gently increases to voltage Vt. Miller integrating circuit 62 has transistor Q62, capacitor C62, resistor R62, and diode D62 for preventing back flow, and generates up-ramp waveform voltage that gently increases to voltage Vr. Miller integrating circuit 63 has transistor Q63, capacitor C63, and resistor R63, and generates down-ramp waveform voltage that gently decreases to voltage Vi4. Switching element Q69 is also a separating switch, and prevents current from flowing back via a parasitic diode or the like of a switching element that forms scan electrode driving circuit 43.

These switching elements and transistors can be formed of a generally known element such as a metal oxide semiconductor field effect transistor (MOSFET) or an insulated gate bipolar transistor (IGBT). These switching elements and transistors are controlled in response to timing signals that occur in timing generating circuit 45, and correspond to the switching elements and transistors.

Next, the operation of scan electrode driving circuit 43, especially the operation in the initializing period and address period of SF1, is described. In the present embodiment, it is assumed that voltage Vi1 shown in FIG. 3 is equal to voltage Vp, voltage Vit is equal to voltage (Vt+Vp), voltage Vi3 is equal to voltage Vs, voltage Vi5 is equal to voltage Vt, and voltage Vc is equal to voltage (Va+Vp). However, these voltages are not limited to this assumption, but can be set appropriately in response to the configuration.

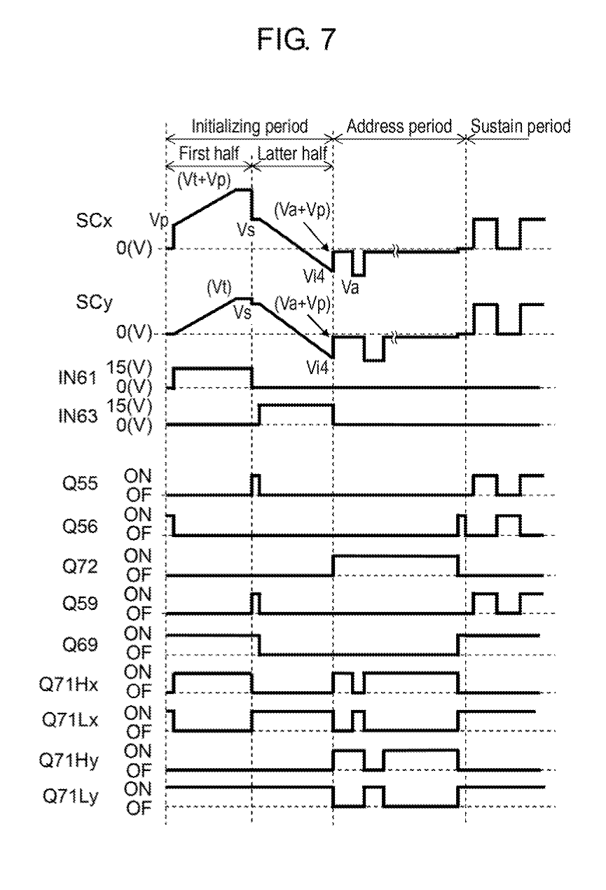

FIG. 7 is a timing chart for illustrating an operation of scan electrode driving circuit 43 of plasma display device 40 in accordance with the first exemplary embodiment of the present invention. In FIG. 7, of scan electrodes SC1 through SCn, the scan electrode undergoing the forcibly initializing operation is denoted with SCx, and the scan electrode undergoing no forcibly initializing operation is denoted with SCy. Of switching elements Q71H1 through Q71Hn, the switching element corresponding to scan electrode SCx is denoted with Q71Hx, and the switching element corresponding to scan electrode SCy is denoted with Q71Hy. Similarly, of switching elements Q71L1 through Q71Ln, the switching element corresponding to scan electrode SCx is denoted with Q71Lx, and the switching element corresponding to scan electrode SCy is denoted with Q71Ly.

In the first half of the initializing period, first, switching element Q56, switching element Q69, switching elements Q71Lx and Q71Ly are set at ON. and voltage 0 (V) is applied to scan electrodes SCx and SCy. Next, switching element Q56 is set at OFF, and voltage Vp is applied to scan electrode SCx undergoing the forcibly initializing operation by setting switching element Q71Lx at OFF and switching element Q71Hx at ON. While, voltage 0 (V) is applied to scan electrodes SCy undergoing no forcibly initializing operation.

Next, a predetermined voltage is applied to input terminal IN61 of Miller integrating circuit 61, and the voltage at node A is gently increased to voltage Vt. Then, the up-ramp waveform voltage that gently increases from voltage Vp to voltage (Vt+Vp) is applied to scan electrode SCx undergoing the forcibly initializing operation. While, the up-ramp waveform voltage that gently increases from voltage 0 (V) to voltage Vt is applied to scan electrode SCy undergoing no forcibly initializing operation.

In the latter half of the initializing period of SF1, first, switching element Q71Hx is returned to OFF, switching element Q71Lx is returned to ON, switching element Q55 and switching element Q59 are set at ON, and voltage Vs is applied to scan electrodes SCx and SCy. Then, switching element Q69 is set at OFF, a predetermined voltage is applied to input terminal IN63 of Miller integrating circuit 63 to operate Miller integrating circuit 63, and the down-ramp waveform voltage that gently decreases to voltage Vi4 is applied to scan electrodes SCx and SCy.

In the subsequent address period, first, transistor Q63 of Miller integrating circuit 63 is set at OFF and switching element Q72 is set at ON, thereby setting the voltage of node A at voltage Va. Switching elements Q71Lx and Q71Ly are set at OFF and switching elements Q71Hx and Q71Hy are set at ON, thereby applying voltage (Va+Vp) to each of scan electrode SCx and SCy.

Next, switching element Q71H1 is set at OFF and switching element Q71L1 is set at ON, and, after a predetermined address time, switching element Q71L1 is returned to OFF and switching element Q71H1 is returned to ON. Thus, a scan pulse is applied to scan electrode SC1. Hereinafter, similarly, scan pulses are sequentially applied to scan electrodes SC2 through SCn.

At this time, the scan pulse at address time TO is applied to scan electrode SCx having undergone the forcibly initializing operation by setting switching element Q71Hx at OFF and switching element Q71Lx at ON and, after address time T0, by returning switching element Q71Lx to OFF and switching element Q71Hx to ON. While, the scan pulse at address time T1 is applied to scan electrode SCy having undergone no forcibly initializing operation by setting switching element Q71Hy at OFF and switching element Q71Ly at ON and, after address time T1, by returning switching element Q71Ly to OFF and switching element Q71Hy to ON.

Then, voltage 0 (V) is applied to scan electrodes SCx and SCy by setting switching element Q72 and switching elements Q71Hx and Q71Hy at OFF, and by setting switching element Q56, switching element Q69, and switching elements Q71Lx and Q71Ly at ON.

Thus, in the present embodiment, the driving voltage waveform of FIG. 3 is applied to scan electrodes SC1 through SCn using scan electrode driving circuit 43.

FIG. 7 shows the example where the value of voltage Vt is set to be higher than that of voltage Vs. However, the value of voltage Vt, may be equal to that of voltage Vs, or the value of voltage Vt may be lower than that of voltage Vs.

In the present embodiment, it is set based on (Rule 1) and (Rule 2) whether the forcibly initializing operation is performed in each scan electrode and each field. When N≧5, it is set based on (Rule 1), (Rule 2) and (Rule 3). However, the present invention is not limited to this, but can be also applied to driving of a loosened condition. One example of this is hereinafter described.

### Second Exemplary Embodiment

In the second exemplary embodiment, a specific scan electrode undergoing the forcibly initializing operation in each field is set based on the following rules. When the forcibly initializing operation is performed once for N fields in one scan electrode, N temporally continuous fields are set as one field group, and M (M≦N) continuously arranged scan electrodes are set as one scan electrode group.

(Rule 1) The field where the forcibly initializing operation is performed in one scan electrode is one field of each field group.

(Rule 2′) The scan electrode undergoing the forcibly initializing operation in one field is zero or one scan electrode of each scan electrode group.

When N≧4,

(Rule 3) in a scan electrode adjacent to the scan electrode undergoing the forcibly initializing operation in a certain field, the forcibly initializing operation is not performed in at least the field and a field next to the field.

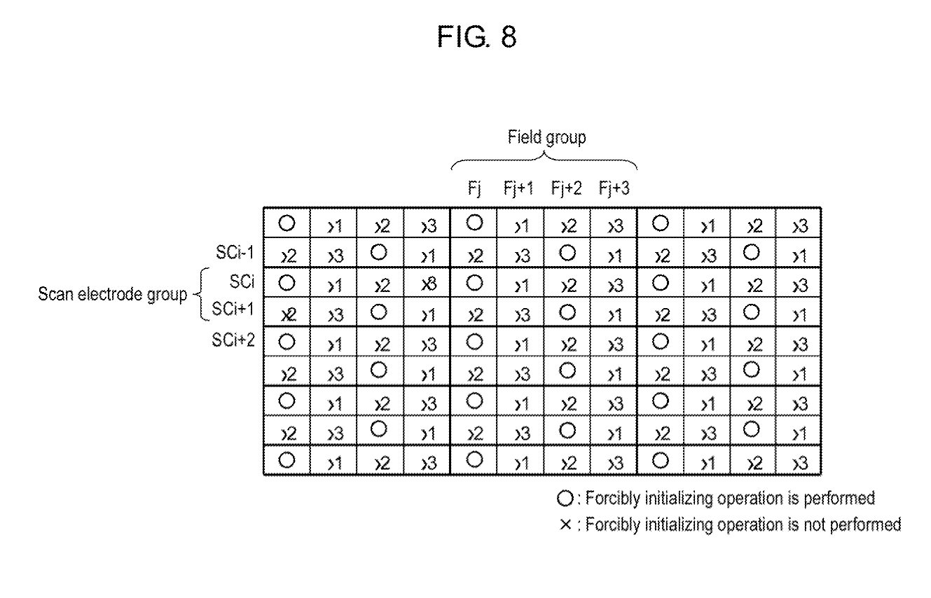

FIG. 8 is a diagram showing the relationship between a discharge cell and a field for undergoing forcibly initializing in accordance with the second exemplary embodiment of the present invention, and shows one example when N=4 and M=2. The horizontal axis shows fields and the vertical axis shows scan electrodes. One field group is formed of fields Fj through Fj+3, and one scan electrode group is formed of scan electrodes SCi and SCi+1. “O” shows that the forcibly initializing operation is performed, and “×1” through “×3” show that the forcibly initializing operation is not performed.

As is clear from FIG. 8. scan electrode SCi undergoes the forcibly initializing operation in one field of each field group. The other scan electrodes are similar to scan electrode SCi (Rule 1). In this case, the number of forcibly initializing operations is reduced to ¼ of that in the case where the forcibly initializing operation is performed in all discharge cells for each field. Therefore, the luminance of black level of a display image can be also reduced to ¼. In field Fj, the forcibly initializing operation is performed in zero or one scan electrode of each scan electrode group. The other fields are similar to field Fj (Rule 2′). Thus, scan electrodes undergoing the forcibly initializing operation can be dispersed in respective fields. Therefore, flicker can be reduced. For example, scan electrode SCi undergoes the forcibly initializing operation in field Fj, and scan electrode SCi−1 and scan electrode SCi+1 adjacent to scan electrode SCi do not undergo the forcibly initializing operation in field Fj and the next field Fj+1. The other scan electrodes are similar to scan electrode SCi (rule 3). Thus, temporal continuity and spatial continuity of the scan electrode undergoing the forcibly initializing operation can be reduced. Therefore, light emission following the forcibly initializing operation is hardly recognized.

In the second embodiment, the address time set for each scan electrode is set to be time T0 in the fields having “O”, set to be time T1 longer than time T0 in the fields having “×1”, set to be time T2 longer than time T1 in the fields having “×2”, and set to be time T3 longer than time T2 in the fields having “×3”.

Here, address time T0 is 1.0 μs, address time T1 is 1.1 μs, address time T2 is 1.3 μs, and address time T3 is 1.6 μs.

The priming caused by the initializing discharge reduces as time passages, and discharge delay to address discharge increases as time passages since the forcibly initializing operation. By setting the address time in such a manner, the address time can be set in response to reduction in priming even when the forcibly initializing operation is performed once for a plurality of fields. Therefore, the address discharge is stably caused.

Specific numerical values shown in the first and second embodiments are simply one example. The present invention is not limited to these numerical values. These numerical values are preferably set optimally in response to the characteristic of the panel or the specification of the plasma display device. These numerical values are allowed to vary in a range for producing the above-mentioned effect.

### INDUSTRIAL APPLICABILITY

The driving method of the present invention can display a high-contrast image, assuming that the forcibly initializing operation is performed once for a plurality of fields. Stable address operation can be performed and high-quality image can be displayed. This driving method is useful as a driving method of a panel.

### REFERENCE MARKS IN THE DRAWINGS

10 panel
22 scan electrode
23 sustain electrode
24 display electrode pair
32 data electrode
40 plasma display device
41 image signal processing circuit
42 data electrode driving circuit
43 scan electrode driving circuit
44 sustain electrode driving circuit
45 timing generating circuit
50 sustain pulse generating circuit
51 electric power recovering circuit
60 ramp waveform voltage generating circuit
61, 62, 63 Miller integrating circuit
70 scan pulse generating circuit

1. A driving method of a plasma display panel that has a plurality of discharge cells, each of the discharge cells having a scan electrode, a sustain electrode, and a data electrode, the driving method comprising:
forming one field using a plurality of subfields having an initializing period, an address period, and a sustain period; and
performing a forcibly initializing operation in each of the discharge cells in one of a plurality of fields, the forcibly initializing operation being in the initializing period, in which a predetermined voltage for causing discharge is applied to the scan electrodes, regardless of presence or absence of discharge before the initializing period, and initializing discharge is performed in the discharge cells,
wherein the address period includes an address time to apply a scan pulse to the scan electrodes and to apply an address pulse to the data electrodes, and the address time in the address period of a field that does not undergo the forcibly initializing operation is set to be longer than the address time in the address period of a field that undergoes the forcibly initializing operation.

2. The driving method of the plasma display panel of claim 1, wherein
when each of the discharge cells undergoes the forcibly initializing operation in one field of N fields (N is natural number), and one scan electrode group is formed of N continuously arranged scan electrodes, the number of scan electrodes to which the predetermined voltage is applied in one field is one in each scan electrode group.

3. The driving method of the plasma display panel of claim 2, wherein
the natural number N is five or more, and to a scan electrode adjacent to a scan electrode to which the predetermined voltage is applied in a certain field, the predetermined voltage is not applied neither in at least the field nor in a field next to the field.
